(19) United States
(12) Patent Application Publication
(10) Pub. No.: US 2015/0199168 A1
(43) Pub. Date: Jul. 16, 2015

(54) Graphic Modeling System and Method

(71) Applicant: DEP Autoline, Inc., Troy, MI (US)

(72) Inventors: Radhakrishnan Mariappasamy, Troy, MI (US); Venkat Saieswar Patnaik, Troy, MI (US)

(73) Assignee: DEP Autoline, Inc.

(21) Appl. No.: 14/595,563

(22) Filed: Jan. 13, 2015

Related U.S. Application Data
(60) Provisional application No. 61/926,513, filed on Jan. 13, 2014.

(51) Int. Cl. G06F 3/14; G06F 3/0487

(52) U.S. Cl. CPC G06F 3/1462; G06F 3/0487; G06T 19/20

(57) ABSTRACT

A graphic modeling system and method for morphing, parameterizing, and/or design-changing very large scale Finite Element and Computational Fluid Dynamics global models by splitting the model into multiple local models. The graphic modeling system and method generally includes a computer software program which is adapted to extract multiple local models, representing regions or design elements of a system, from a singular global model. Changes may be made independently to each of the local models by different individuals or teams of individuals. Upon completion, the changes from the local models will be combined and incorporated into a modified global model. In such a manner, multiple individuals or teams may work on different regions and/or design elements of a single global model without undue burden in merging the changes of each individual or team into the global model after modifications are completed on each local model.

### CROSS REFERENCE TO RELATED APPLICATIONS

I hereby claim benefit under Title 35, United States Code, Section 119(e) of U.S. provisional patent application Ser. No. 61/926,513 filed Jan. 13, 2014. The 61/926,513 application is currently pending. The 61/926,513 application is hereby incorporated by reference into this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to a modeling system and more specifically it relates to a graphic modeling system and method for morphing, parameterizing, and/or design-changing very large scale Finite Element and Computational Fluid Dynamics global models by splitting the model into multiple local models.

2. Description of the Related Art

Any discussion of the related art throughout the specification should in no way be considered as an admission that such related art is widely known or forms part of common general knowledge in the field.

When working with large-scale global models, such as Finite Element and Computational Fluid Dynamics models, it is often required that multiple individuals simultaneously work on different regions or elements of the same global models. In such situations, it can be burdensome to update the global model with the different changes from multiple individuals to different regions or elements of the model.

Existing prior art does not provide an automated process for the data integration between global and local models (representing changes to regions or elements). In such prior art solutions, the local model can be exported and then morphed/parameterized/design-changed, but the changes in the local models must be manually updated to the global model. This can be very time-consuming and often requires a high degree of technical knowledge to handle the data integration.

Management of synchronization changes to multiple regions or elements of a global model can be extremely arduous in light of many changes to different regions. For these reasons, existing prior art does not allow multiple individuals or teams to work in parallel on different regions or elements of a global model without undue burden.

Because of the inherent problems with the related art, there is a need for a new and improved graphic modeling system and method for morphing, parameterizing, and/or design-changing very large scale Finite Element and Computational Fluid Dynamics global models by splitting the model into multiple local models.

### BRIEF SUMMARY OF THE INVENTION

The invention generally relates to a graphic modeling system which automatically and efficiently combines changes made to multiple local models into a modified global model. The present invention is generally a computer software program which is adapted to extract multiple local models, representing regions or design elements of a system, from a singular global model. Changes may be made independently to each of the local models by different individuals or teams of individuals. Upon completion, the changes from the local models will be combined and incorporated into a modified global model. In such a manner, multiple individuals or teams may work on different regions and/or design elements of a single global model without undue burden in merging the changes of each individual or team into the global model after modifications are completed on each local model.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto. In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a block diagram of an exemplary computer system for practicing the present invention.

FIG. 2 is an exemplary user interface illustrating a global model.

FIG. 3 is an illustration of a first local model prior to modifications.

FIG. 4 is an illustration of a first local model after modifications.

FIG. 5 is an illustration of a second local model prior to modifications.

FIG. 6 is an illustration of a second local model after modifications.

FIG. 7 is an illustration of an exemplary interface being used to begin the merging process.

FIG. 8 is an illustration of an exemplary merge window of the present invention.

FIG. 9 is an illustration of an exemplary global model after merging of changes from local models.

FIG. 10 is an illustration of the first modified local model after merging with the global model.

FIG. 11 is a flowchart illustrating exporting of local models from a global model.

FIG. 12 is a flowchart illustrating modification of a first local model.

FIG. 13 is a flowchart illustrating modification of a second local model.

FIG. 14 is a flowchart illustrating changes to local models being merged with the global model.

FIG. 15 is a flowchart illustrating removal of duplicate ID's from a global model after merging of local models.

### DETAILED DESCRIPTION OF THE INVENTION

### A. Introduction

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein. The present invention may be operated as a computer program installed upon a computer system 100 (i.e. a computer used for computer-aided-engineering/Finite-element-analysis, such as with a CAE/FEA program or mesh program as known in the arts), via a website or other system.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs), DVDs (digital video discs), flash drives, USB drives and computer instruction signals embodied in a transmission medium (with or without a carrier wave upon which the signals are modulated). For example, the transmission medium may include a communications network, such as the Internet.

### B. Exemplary Computer System

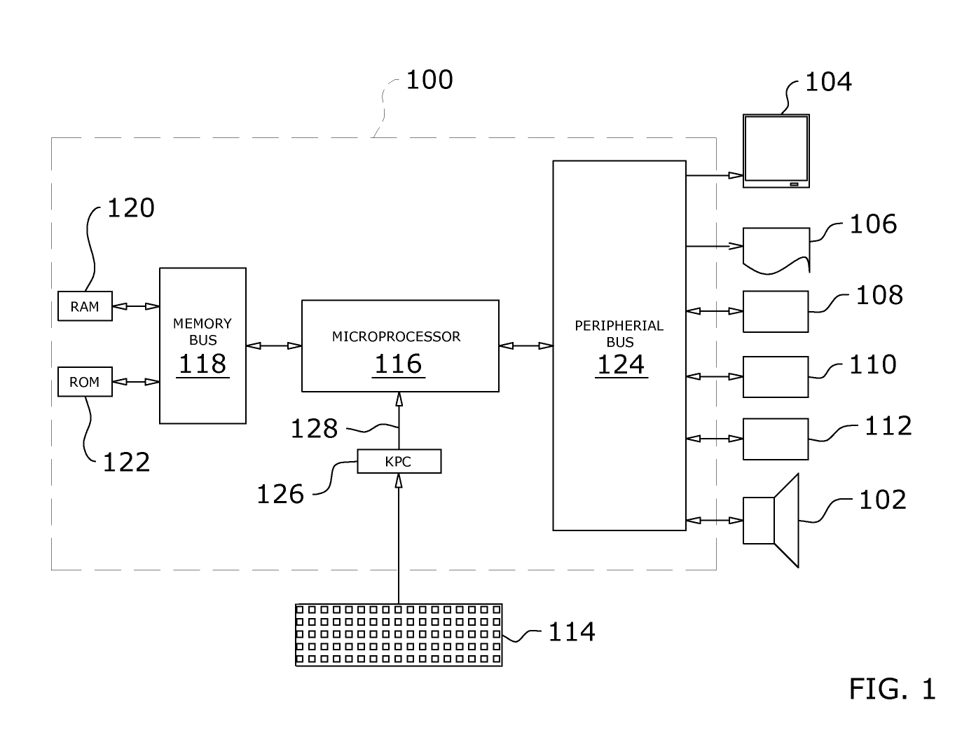

FIG. 1 is a block diagram of an exemplary computer system 100 for practicing the various aspects of the present invention. The computer system 100 includes a display screen (or monitor) 104, a printer 106, a floppy disk drive 108, a hard disk drive 110, a network interface 112, and a keyboard 114. The computer system 100 also includes a microprocessor 116, a memory bus 118, random access memory (RAM) 120, read only memory (ROM) 122, a peripheral bus 124, and a keyboard controller 126. Computer system 100 can be a personal computer (such as an APPLE computer, an IBM computer, or one of the compatibles thereof), a workstation computer (such as a SUN MICROSYSTEMS or HEWLETT-PACKARD workstation), or various other types of computers. It can be appreciated that the computer system 100 may be comprised of various other electronic devices including but not limited to mobile phones, telephones, personal digital assistants (PDAs), handheld wireless devices, two-way radios, smart phones, communicators, video viewing units, television units, television receivers, cable television receivers, pagers, communication devices, and digital satellite receiver units.

The microprocessor 116 is a general-purpose digital processor that controls the operation of the computer system 100. Microprocessor 116 can be a single-chip processor or implemented with multiple components. Using instructions retrieved from memory, microprocessor 116 controls the reception and manipulations of input data and the output and display of data on output devices.

The memory bus 118 is utilized by the microprocessor 116 to access the RAM 120 and the ROM 122. RAM 120 is used by microprocessor 116 as a general storage area and as scratch-pad memory, and can also be used to store input data and processed data. ROM 122 can be used to store instructions or program code followed by microprocessor 116 as well as other data.

Peripheral bus 124 is used to access the input, output and storage devices used by the computer system 100. In the described embodiment(s), these devices include a display screen 104, a printer device 106, a floppy disk drive 108, a hard disk drive 110, and a network interface 112. A keyboard controller 126 is used to receive input from the keyboard 114 and send decoded symbols for each pressed key to microprocessor 116 over bus 128.

The display screen 104 is an output device that displays images of data provided by the microprocessor 116 via the peripheral bus 124 or provided by other components in the computer system 100. The printer device 106 when operating as a printer provides an image on a sheet of paper or a similar surface. Other output devices such as a plotter, typesetter, etc. can be utilized in place of, or in addition to, the printer device 106.

The floppy disk drive 108 and the hard disk drive 110 can be utilized to store various types of data. The floppy disk drive 108 facilitates transporting such data to other computer systems, and the hard disk drive 110 permits fast access to large amounts of stored data.

The microprocessor 116 together with an operating system operate to execute computer code and produce and use data. The computer code and data may reside on RAM 120, ROM 122, or hard disk drive 110. The computer code and data can also reside on a removable program medium and loaded or installed onto computer system 100 when needed. Removable program mediums include, for example, CD-ROM, PC-CARD, floppy disk and magnetic tape.

The network interface circuit 112 is utilized to send and receive data over a network connected to other computer systems. An interface card or similar device and appropriate software implemented by microprocessor 116 can be utilized to connect the computer system 100 to an existing network and transfer data according to standard protocols.

The keyboard 114 is used by a user to input commands and other instructions to the computer system 100. Other types of user input devices can also be used in conjunction with the present invention. For example, pointing devices such as a computer mouse, a track ball, a stylus, or a tablet to manipulate a pointer on a screen of the computer system 100.

The present invention can also be embodied as computer readable code on a computer readable medium. The computer readable medium is any data storage device that can store data which can be thereafter be read by a computer system. Examples of the computer readable medium include read-only memory, random-access memory, magnetic data storage devices such as diskettes, and optical data storage devices such as CD-ROMs. The computer readable medium can also be distributed over a network coupled computer systems so that the computer readable code is stored and executed in a distributed fashion.

The present invention may be embodied within various languages and technologies such as but not limited to JAVA, JAVASCRIPT, JSCRIPT, WMLSCRIPT, ACTIVEX, CGI, scripts, plug-ins, BASIC, VISUAL BASIC, C, C++, COBOL, FORTRAN, ADA, HTML, DHTML, XML, SGML, WML, HDML, FLASH, SHOCKWAVE, GIF, JPEG, ADOBE ACROBAT, PDF, MICROSOFT WORD, and PASCAL. The present invention may be operated upon various operating systems such as but not limited to UNIX, MACINTOSH, LINUX, WINDOWS, PALMOS, EPOC, WINDOWS CE, FLEXOS, OS/9, and JAVAOS.

### B. Exemplary Global Computer Network

The global computer network (e.g. Internet) is an exemplary communications network which may be utilized in combination with the present invention. The Internet is basically comprised of a “global computer network.” A plurality of computer systems 100 around the world are in communication with one another via this global computer network and are able to transmit various types of data between one another. The communications between the computer systems may be accomplished via various methods such as but not limited to wireless, Ethernet, cable, direct connection, telephone lines, and satellite. One or more web servers typically provide the data to the computer systems connected via the Internet.

The present invention may also be utilized upon global computer networks, local area networks (LAN), wide area networks (WAN), campus area networks (CAN), metropolitan-area networks (MAN), and home area networks (HAN). Various protocols may be utilized by the electronic devices for communications such as but not limited to HTTP, SMTP, FTP and WAP (Wireless Application Protocol). The present invention may be implemented upon various wireless networks such as but not limited to CDPD, CDMA, GSM, PDC, PHS, TDMA, FLEX, REFLEX, IDEN, TETRA, DECT, DATATAC, and MOBITEX. The present invention may also be utilized with online services and internet service providers such as AMERICA ONLINE (AOL), COMPUSERVE, WEBTV, and MSN INTERNET SERVICES. The present invention preferably utilizes the Internet for transmitting data, however it can be appreciated that as future technologies are created that various aspects of the invention may be practiced with these improved technologies.

The present invention is preferably embodied within a software application installed upon the Finite-element-analysis computer system 100. Any type of computer 100 known in the art may be utilized to practice the present invention, including personal computers, laptop computers, tablet computers, smart phones and the like. The present invention may also be embodied in various other manners such as but not limited to a central server computer or a web server that performs all functionality server-side and merely provide the results of the merged data to the computer 100.

### C. Global and Local Models

The present invention is adapted to automatically and efficiently merge changes from multiple local models 40, 50 into a singular global model 30. The global and local models 30, 40, 50 may be embodied in various types of files known in the art to store data to assist with Finite-element-models. Various FEM (Finite Element Model) file formats known in the art may be utilized such as Nastran, Dyna, Abaqus and other solver formats. The design elements of the global model 30 may have been previously compiled or prepared using any number of FEM software programs known in the art, such as Nastran, Dyna, Abaqus and other FEM solver formats.

The global model 30 is in a computer readable file format and may be available directly from the computer system 100 or via downloading through a global computer network 12. The global model 30 may comprise models typically used in the Finite-element-analysis art to represent a plurality of design elements, such as Finite Element (FE) models and Computational Fluid Dynamics (CFD) models.

The global model 30 will generally comprise a binary data file. The binary data file may in some embodiments have been converted from a prior data file, such as a Solver model from a Finite-element-model software such as Meshworks. The global model 30 will generally represent a plurality of design elements 42, 52 which, taken together, form an assembly of parts such as a vehicle as shown in the figures. In some embodiments, the global model 30 may be retained on a remote server and the functionality of the present invention may be performed either by the local computer 100 or by the remote server directly, with the results being transmitted to the local computer after processing.

The local models 40, 50 are exported directly from the global model 30. Each local model 40, 50 will generally represent all of the design elements 42, 52 from a particular region of the global model 30. In some embodiments, each local model 40, 50 may represent one or more design elements 42, 52, whether they are in the same region or not. For example, multiple design elements 42, 52 from a single region of the global model 30 may be simultaneously modified using the present invention.

Alternatively, multiple design elements from multiple regions of the global model 30 may also be simultaneously modified using the present invention. In such a manner, multiple individuals or teams may work on different regions and/or design elements 42, 52 of a single global model 30 without undue burden in merging the changes of each individual or team into the global model 30 after modifications are completed on each local model 40, 50.

Each local model 40, 50 is exported from the global model 30 using the present invention as discussed herein. When exporting each local model 40, 50, the present invention will save two copies of the local model 40, 50: a user copy and a reference copy. As changes such as morphing, parameterization, or design changes are entered on the local model 40, 50, these changes will be reflected in the user copy of the local model 40, 50. The reference copy is maintained in the same state as when extracted from the global model 30 so as to provide a reference to the local model 40, 50 prior to any changes.

The local models 40, 50, including the user copies and reference copies, may be stored on any number of computer systems 100, and need not all be stored on the same machine. Thus, multiple local models 40, 50 from the same global model 30 may be distributed across a number of computer systems 100; even in cases where the computer systems 100 are geographically separated. In such a case, the communications network 12 may be utilized to provide communication between the global model 30 and the various local models 40, 50.

The design elements stored within the global and local models 30, 40, 50 may comprise a Finite-element-analysis or mesh of any type of design element 42, 52, such as parts or assemblies of parts, such as vehicular design elements as shown in the figures. It is appreciated that the present invention may be utilized with any type of design elements 42, 52 which are stored within a data file. While the figures illustrate design elements comprised of vehicular parts, it should be appreciated that this is merely for exemplary purposes and various different mechanisms, machines, devices, and the like may be supported by the present invention. Further, design elements 42, 52 need not represent physical, tangible structures but may also include parameters, dimensions, and other parameters.

### D. User Interface

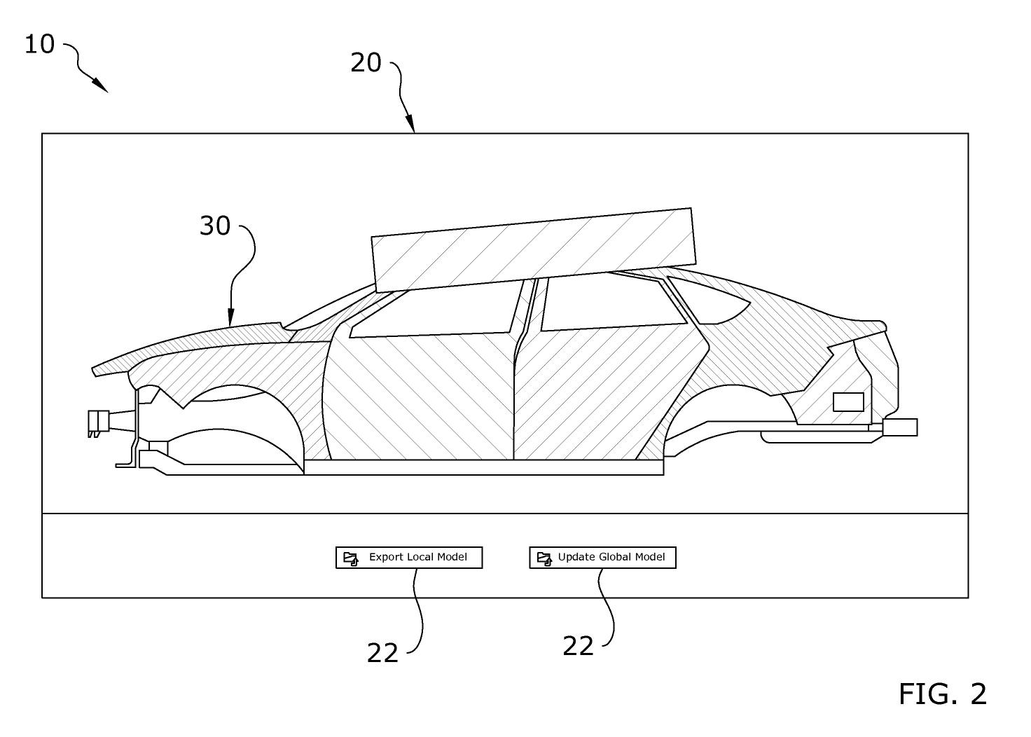

FIGS. 2, 7, and 8 illustrate exemplary user interfaces 20 for use with the present invention. It should be appreciated that the exemplary user interface 20 shown in the figures is merely for illustrative purposes only. It should be appreciated that the user interface 20 utilized with the present invention may vary widely between different embodiments. The user interface 20 may thus be similar to the exemplary user interface 20 of the figures or may be markedly different in alternate embodiments.

Generally, as shown in FIG. 2, the user interface 20 will include one or more selectors 22 for performing various functions. For simplicity, the figures merely illustrate two selectors 22: “export local model” and “update global model”. It should be appreciated that these two selectors 22 are not necessary for the present invention to function. The positioning, wording, orientation, and appearance of selectors 22 of the user interface 20 will vary in different embodiments. It is expected that the present invention's user interface 20 will generally include far more selectors 22 than shown in the figures, including ribbons of selectors 22 for performing the various functions common to design and mesh software.

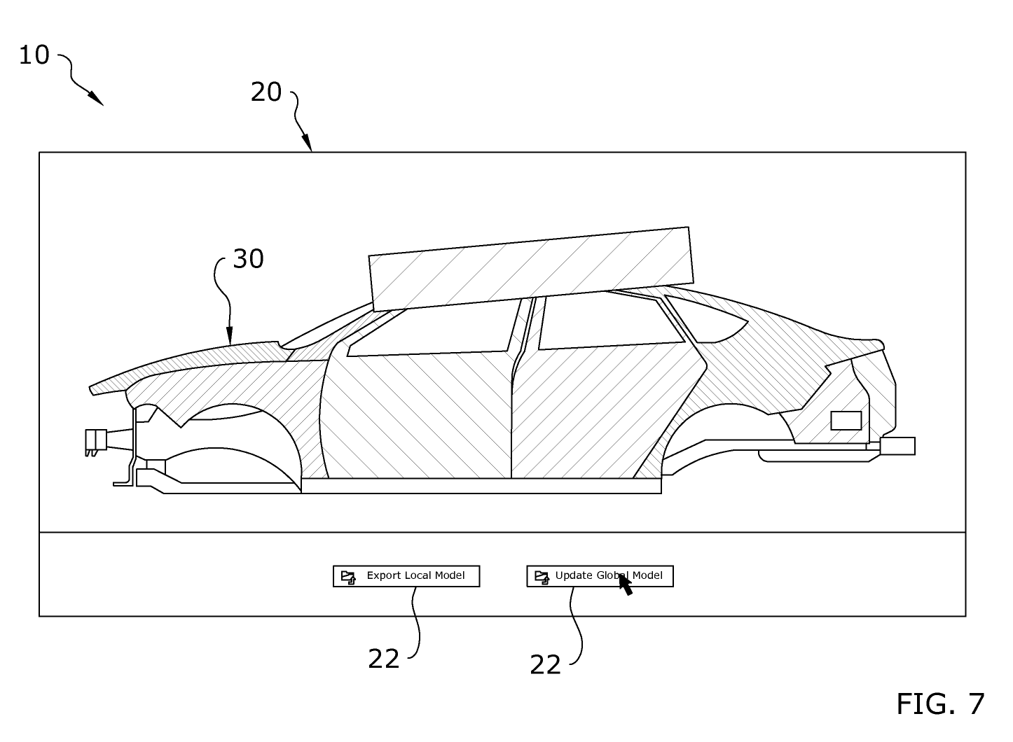

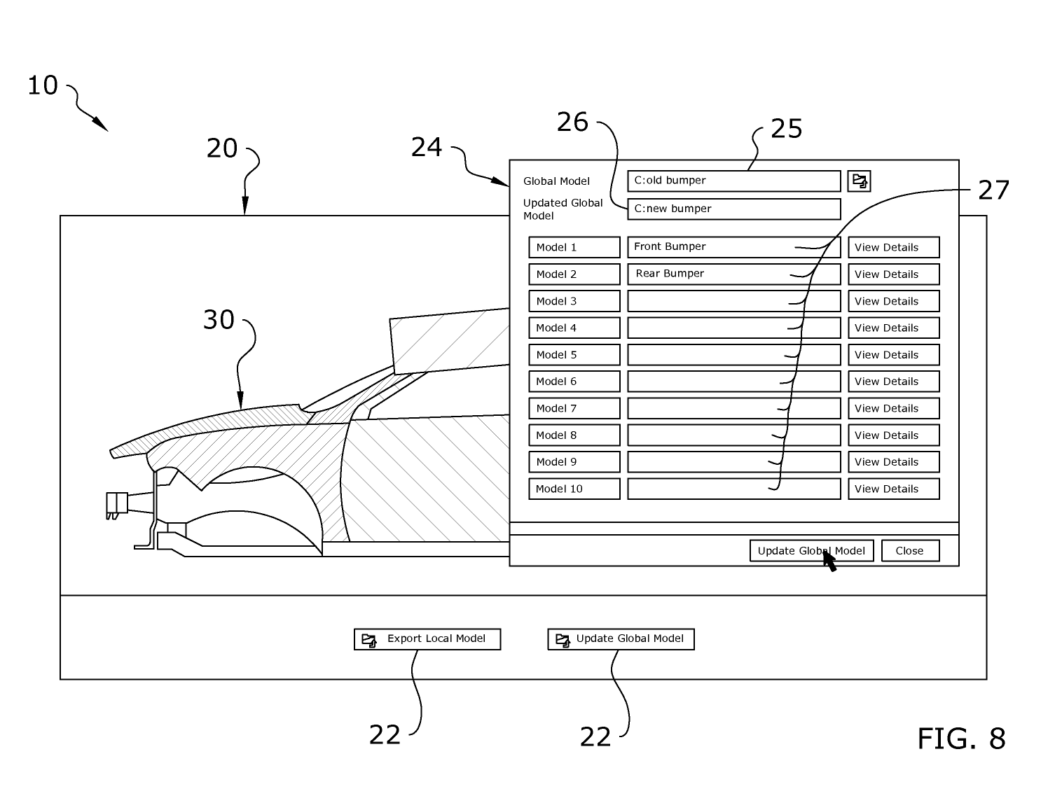

FIGS. 7 and 8 illustrate an exemplary merge window 24 for use with the present invention. As with all other elements of the user interface 20, the positioning, wording, orientation, and appearance of the merge window 24 may vary in different embodiments. The exemplary configuration shown in the figures thus should not be construed as limiting on the scope of the present invention.

The merge window 24 provides merging functionality between multiple local models and a global model. An exemplary merge window 24 as shown in FIG. 8 includes a global input 25, global output 26, and a plurality of local inputs 27. The global input 25 will allow the user to browse to or select a global model in binary file format (such as after being extracted from a mesh program). The global output 26 will allow the user to select a file to which the updated global model 30 will be saved after merged with the local models 40, 50. The local inputs 27 are each populated with a local model 40, 50 which is to be merged with the global model 30 and other local models 40, 50 to perform the functionality of the present invention.

### E. Operation of the Present Invention

The present invention is directed to methods, apparatuses, systems and computer-readable medium embodying software for performing the methods and enabling the system to morph a FE design element 20 automatically from one configuration to a second, morphed configuration. In a preferred embodiment, the present invention is a software program written in C++, though it could in different embodiments be written in various other programming languages such as Java, FORTRAN, etc., which may operate in a standalone fashion or in combination with a CAE/FEA software program such as Meshworks.

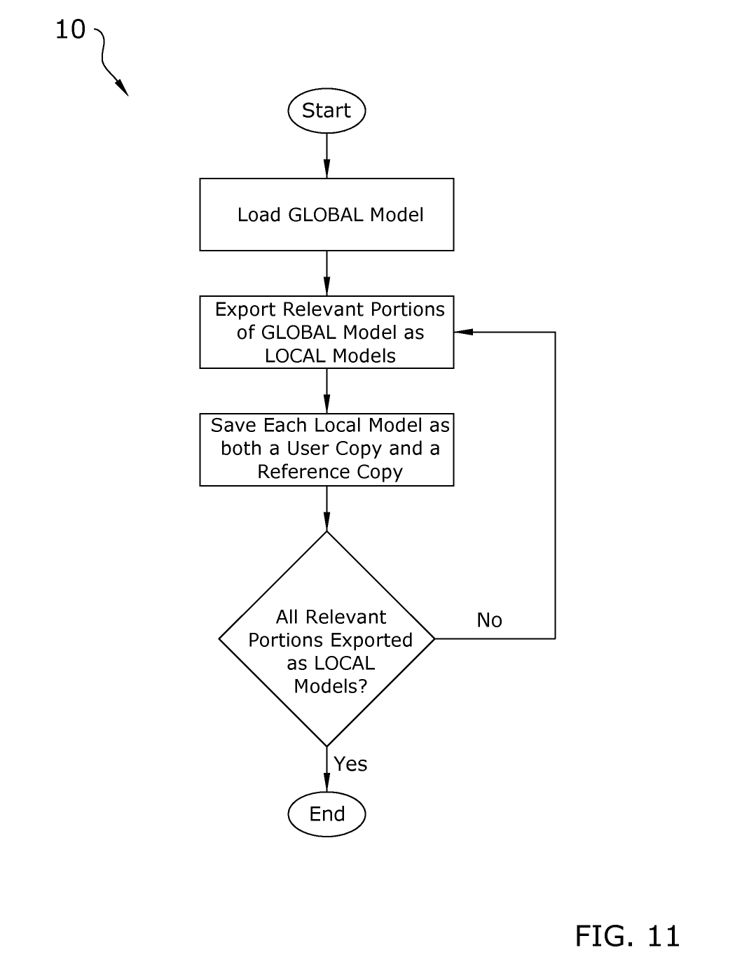

FIGS. 11-15 illustrate the overall operation of the present invention. As shown in FIG. 11, the present invention will first load a global model 30. Generally, a Solver model or other modeling source will be converted into a binary data file which will function as the global model 30. The portions, regions, or design elements of the global model 30 which are of interest to the user will be exported as local models 40, 50.

While this functionality may be performed in various ways, one embodiment will utilize the “export local model” selector 22 of the user interface 20 to select regions, portions, or design elements to be exported to a local model 40, 50. This step may be repeated for each of the regions, portions, or design elements 42, 52 which are desired to be exported for modification. Thus, multiple local models 40, 50 may be created from the singular global model 30, with each of the local models 40, 50 representing a different region, portion, or number of design elements 42, 52 from the global model 30.

For each such local model 40, 50 extracted from the global model 30, two files will be saved on the computer system 100. A user copy will be saved which will track any changes made to the local model 40, 50 as they are being performed by the user. A reference copy will be saved which will remain unchanged and thus provide a reference to the local model 40, 50 prior to any design changes or the like being performed.

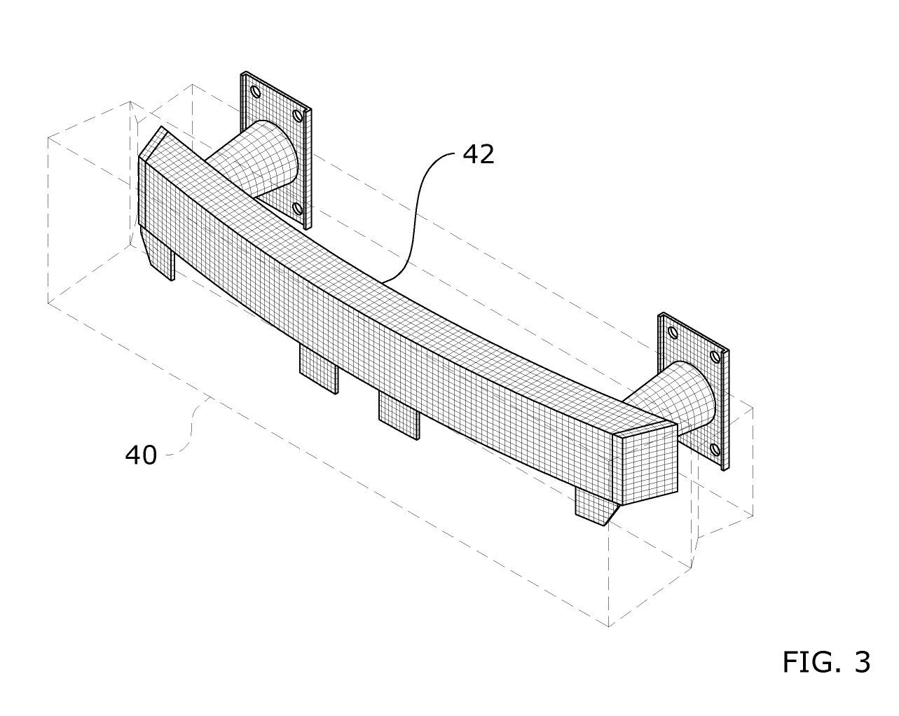

After extracting the local models 40, 50, each may be modified such as by morphing, parameterization, or entering any other changes to the design elements 42, 52 or overall make-up of the local model 40, 50. FIG. 3 illustrates a first local model 40 which has been extracted from the global model 30 shown in FIG. 2. As can be seen, the first local model 40 includes boxing which surrounds the design elements 42 to illustrate the bounds of the local model 40. The exemplary first local model 40 is shown as comprising a plurality of first design elements 42 which, taken together, form the front bumper of a vehicle.

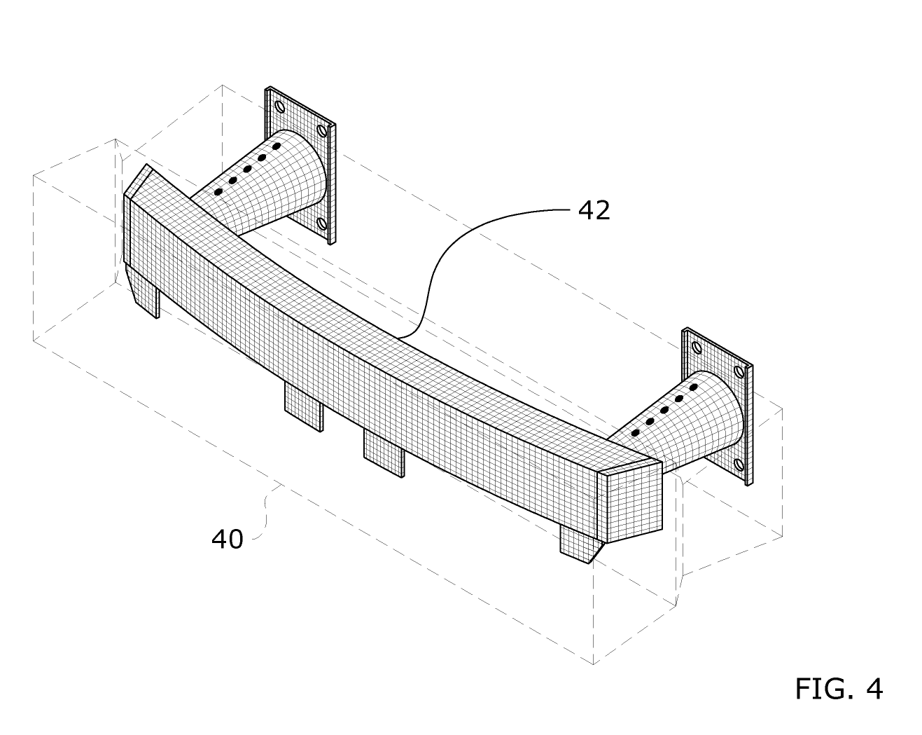

FIG. 4 illustrates changes being made to the first local model 40. In this case, the first local model 40 has been parameterized and its first design elements 42 have been modified. Specifically, the lengths of the connector portions of the front bumper have been elongated and weld-spots have been added. Thus, FIG. 4 shows a morphed first local model 40 after first design elements 42 have been changed.

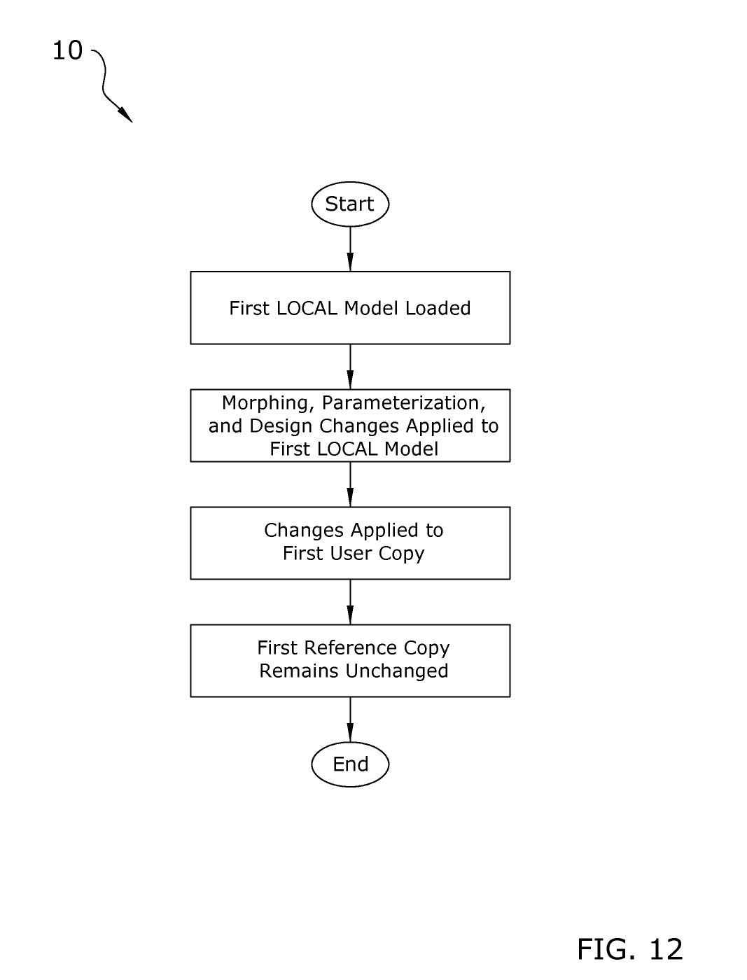

FIG. 12 illustrates the overall process of modifications to the first local model 40. As shown, the first local model 40 is loaded and any morphing, parameterization, and design changes are applied to the first local model 40. These changes are reflected in the user copy of the first local model 40 while the reference copy remains unchanged.

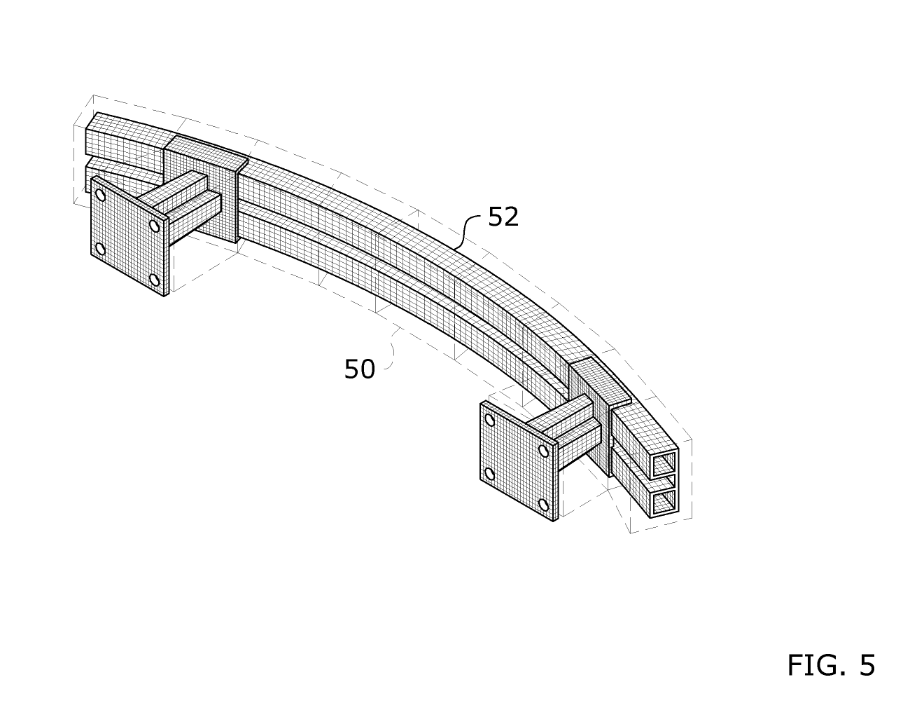

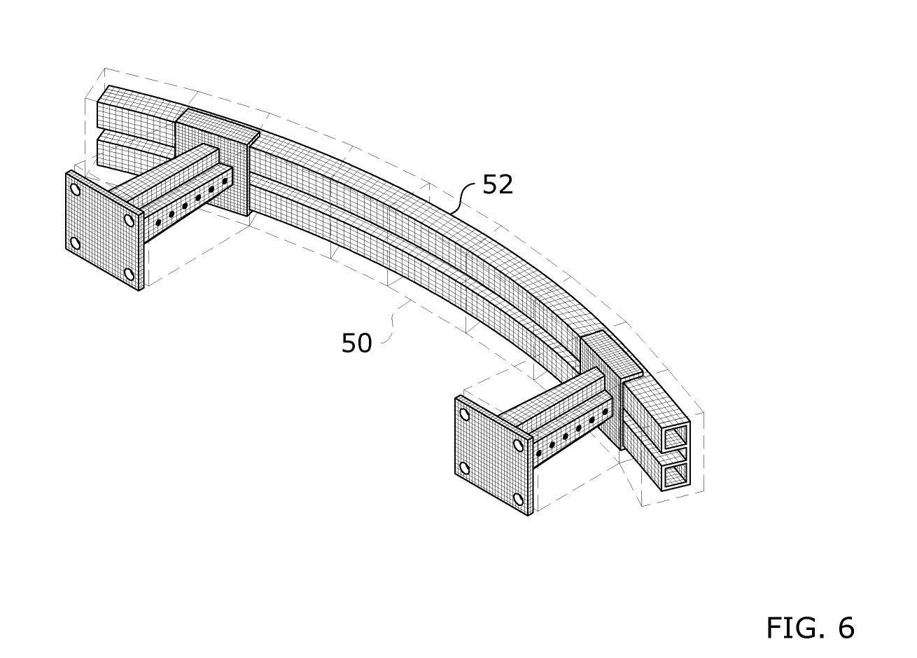

FIG. 5 illustrates a second local model 50 which has been extracted from the global model shown in FIG. 2. The exemplary second local model 50 is shown as comprising a plurality of second design elements 52 which, taken together, form the rear bumper of a vehicle. FIG. 6 illustrates changes being made to the second local model 50, including parameterization and modification of second design elements 52. Specifically, the lengths of the connector portions of the rear bumper have been similarly elongated and weld-spots have been added. Thus, FIG. 6 shows a morphed second local model 50 after second design elements 52 have been changed.

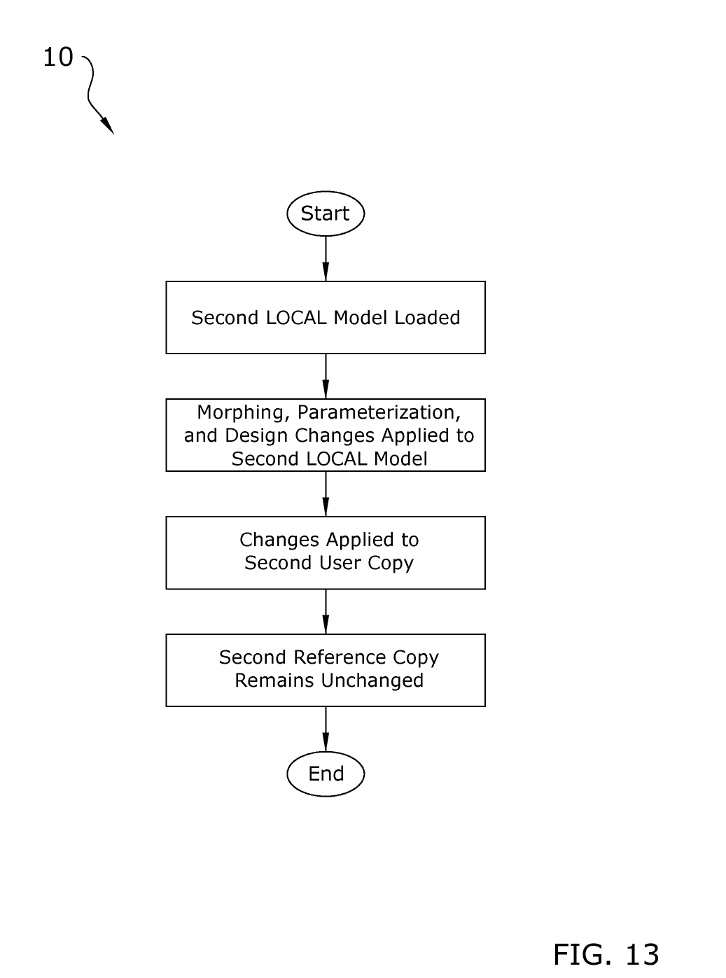

FIG. 13 illustrates the overall process of modifications to the second local model 50. As shown, the second local model 50 is loaded and any morphing, parameterization, and design changes are applied to the second local model 50. These changes are reflected in the user copy of the second local model 50 while the reference copy remains unchanged.

While this description merely discusses two local models 40, 50 being modified for simplicity, it should be appreciated that far more local models 40, 50 may be modified and supported by the present invention. Thus, it should be appreciated that any number of local models 40, 50 may be supported by the present invention and are not limited to the two shown in the figures.

FIG. 8 illustrates an exemplary user interface 20 being used to combine changes to multiple local models 40, 50. As can be seen, the global model 30 has been loaded into the global input 25 of the merge window 24. An output global model 30 is selected in the global output 26 to which the merged and morphed global model 30 will be saved. The local inputs 27 have been populated with the first local model 40 and the second local model 50. Upon selecting “Update Global model” as shown, the present invention will automatically and efficiently combine the changes from the local models 40, 50 into the global model 30 as discussed below.

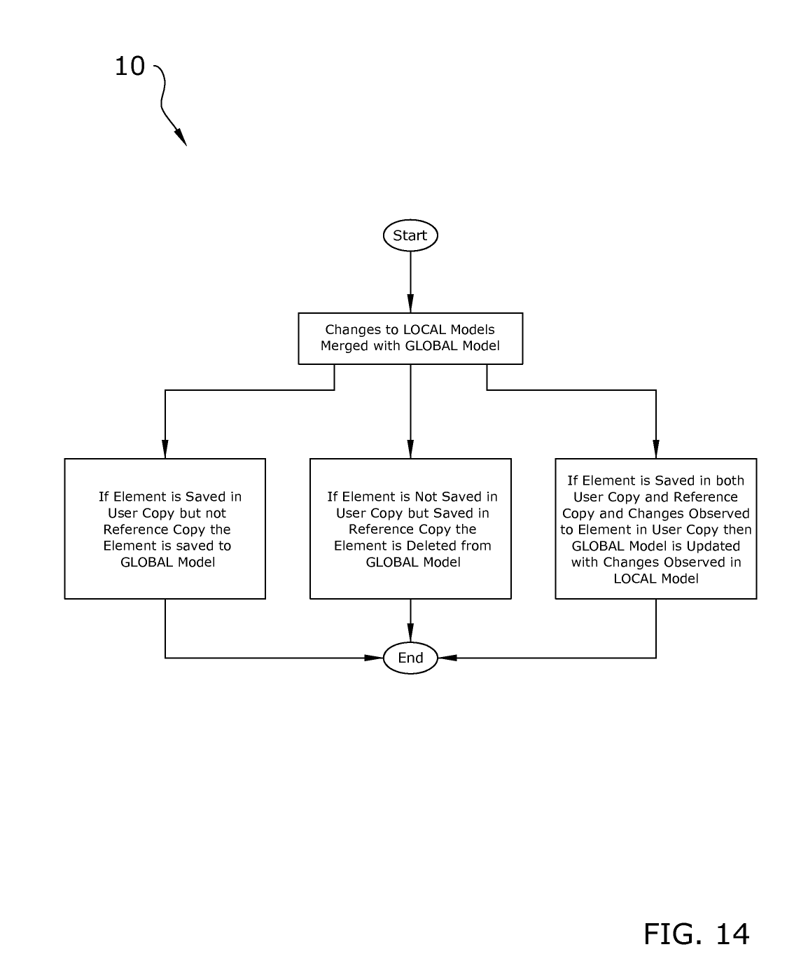

FIG. 14 is a flowchart illustrating exemplary steps for merging changes to multiple local models 40, 50 into a global model 30. As can be seen, one of three actions will be performed by the computer system 100 depending on the changes reflected in the user and reference copies of the local models 40, 50.

For each local model 40, 50, the design elements 42, 52 of the user copy are compared to the design elements 42, 52 of the reference copy. It should be appreciated that design elements 42, 52 may include entity or meta data such as parameters, welds, mesh patterns, parameters, nodes, sections, loads, adhesives, morph-sets, design variables, etc.

If design elements 42, 52 are shown in the user copy but not in the reference copy of the local model 40, 50, the design elements 42, 52 will be added to the modified global model 30. If design elements 42, 52 are shown in the reference copy but not in the user copy of the local model 40, 50, the design elements 42, 52 will be removed from the modified global model 30. If design elements 42, 52 are present in both the user copy and the reference copy and changes are observed in the design elements 42, 52, then the modified global model 30 will be updated with the changes observed in the local model 40, 50.

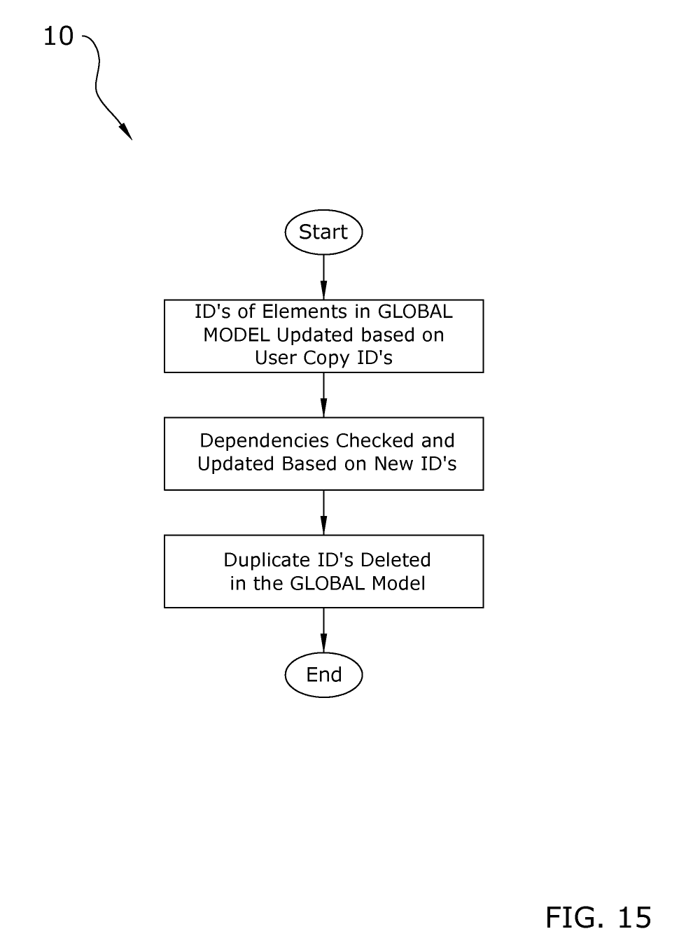

In all of the above steps, the implementation will update the dependencies as and when it is required as shown in FIG. 15. Dependencies may include any related data to the design elements 42, 52 being modified, updated, or deleted. For example, the contact definition associated with a set of finite design elements 42, 52 represents one such dependency. Just before the merging process takes place, the ID of design elements 42, 52 are modified in the modified global model 30 based on the highest ID's found in the user copy of the local models 40, 50. This will aid in eliminating duplicate ID's in the global model 30 after modification. Once ID's are renumbered, all dependencies are checked and updated properly in order to maintain data integrity of the modified global model 30.

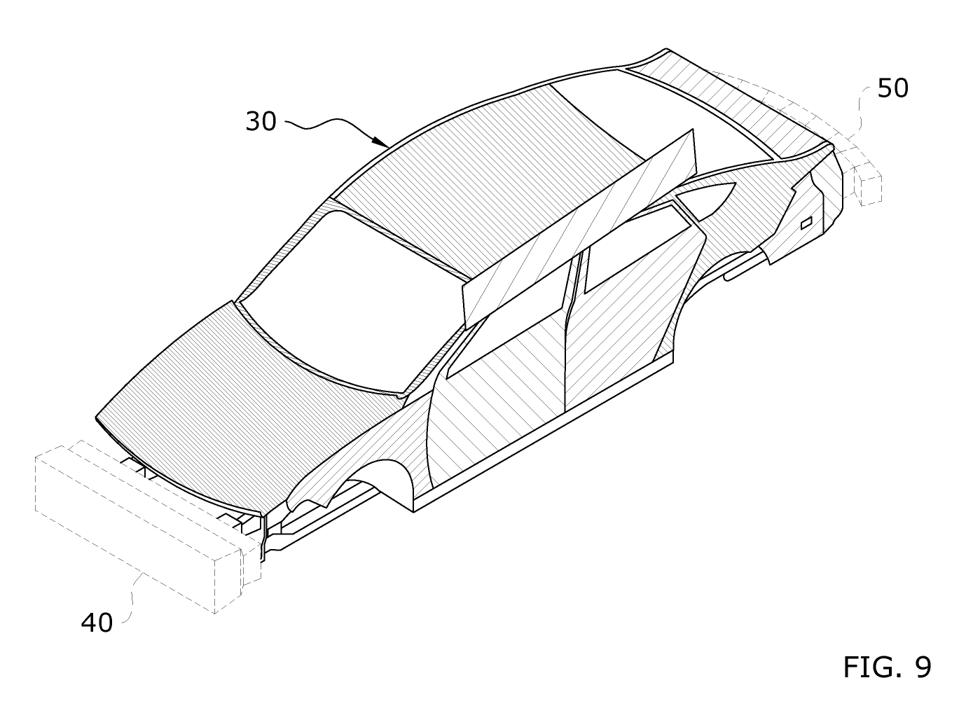

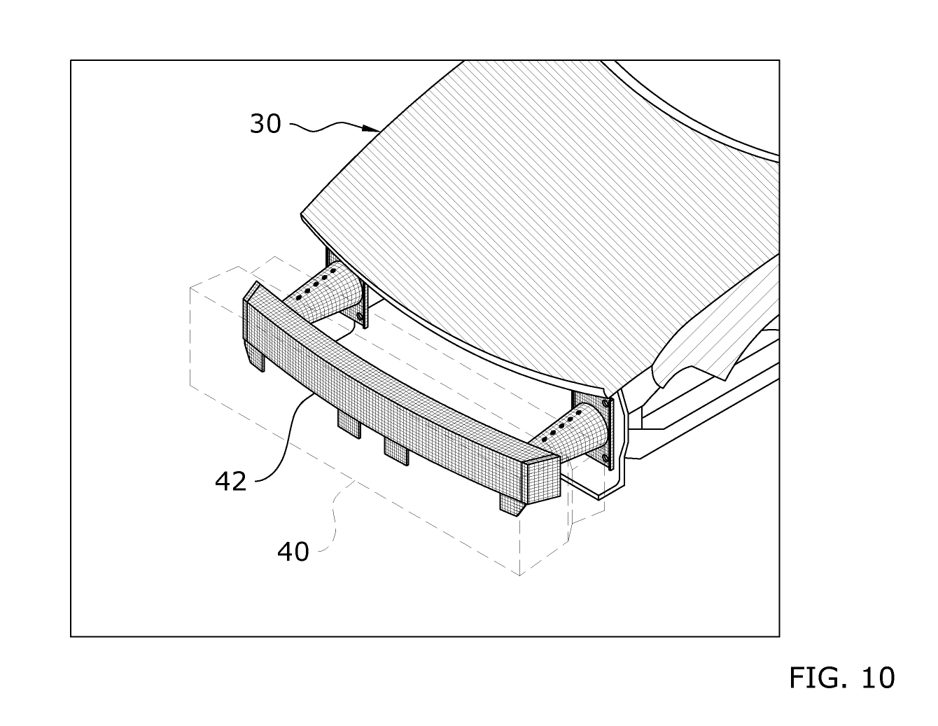

FIG. 9 illustrates a modified global model 30 which shows that the local models 40, 50 have been updated with the changes from FIGS. 4 and 6. FIG. 10 focuses on the second local model 40 after merging has been performed, showing that the changes to the design elements 42 of the local model 40 have been incorporated into the modified global model 30. Although not shown, it should be appreciated that the changes to the design elements 52 of the second local model 50 have been similarly modified.

Any and all headings are for convenience only and have no limiting effect. Unless otherwise defined, all technical and scientific terms used herein have the same meaning as commonly understood by one of ordinary skill in the art to which this invention belongs. Although specific terms are employed herein, they are used in a generic and descriptive sense only and not for purposes of limitation. All publications, patent applications, patents, and other references mentioned herein are incorporated by reference in their entirety to the extent allowed by applicable law and regulations.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs), DVDs (digital video discs), and computer instruction signals embodied in a transmission medium (with or without a carrier wave upon which the signals are modulated). For example, the transmission medium may include a telecommunications network, such as the Internet.

The invention is described above with reference to block and flow diagrams of systems, methods, apparatuses, and/or computer program products according to example embodiments of the invention. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the invention. These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks. Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

The present invention may be embodied in other specific forms without departing from the spirit or essential attributes thereof, and it is therefore desired that the present embodiment be considered in all respects as illustrative and not restrictive. Many modifications and other embodiments of the invention will come to mind to one skilled in the art to which this invention pertains and having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although methods and materials similar to or equivalent to those described herein can be used in the practice or testing of the present invention, suitable methods and materials are described above. Thus, the present invention is not intended to be limited to the embodiments shown, but is to be accorded the widest scope consistent with the principles and features disclosed herein.

The invention claimed is:

1. A method of integrating design element changes into a global model, comprising:
loading a global model by a computer system, wherein said global model includes a plurality of design elements;
extracting a first local model from said global model, wherein said first local model includes one or more of said design elements;
extracting a second local model from said global model, wherein said second local model includes one or more of said design elements;
modifying said one or more design elements of said first local model to create a modified first local model;
modifying said one or more design elements of second local model to create a modified second local model; and
merging said modified first local model and said modified second local model with said global model by said computer system.

2. The method of claim 1, wherein said design elements comprise different regions of said global model.

3. The method of claim 1, wherein said design elements comprise different parameters of said global model.

4. The method of claim 1, wherein said first local model comprises a first user copy and a first reference copy and wherein said second local model comprises a second user copy and a second reference copy.

5. The method of claim 4, wherein said modified first local model is comprised of said first user copy and wherein said first reference copy comprises said one or more design elements of said global model in an unchanged state.

6. The method of claim 5, further comprising the step of comparing said one or more design elements of said first reference copy with said one or more design elements of said first user copy.

7. The method of claim 6, wherein said merging step comprises adding said one or more design elements of said first user copy to said modified global model if said one or more design elements of said first user copy are not present in said first reference copy.

8. The method of claim 6, wherein said merging step comprises removing said one or more design elements of said first reference copy from said modified global model if said one or more design elements of said first reference copy are not present in said first user copy.

9. The method of claim 6, wherein said merging step comprises modifying said one or more design elements of said modified global model to match changes observed to said one or more design elements of said first user copy.

10. The method of claim 7, wherein said modified second local model is comprised of said first user copy and wherein said first reference copy comprises said one or more design elements of said global model in an unchanged state.

11. The method of claim 10, further comprising the step of comparing said one or more design elements of said second reference copy with said one or more design elements of said second user copy.

12. The method of claim 11, wherein said merging step comprises adding said one or more design elements of said second user copy to said modified global model if said one or more design elements of said second user copy are not present in said second reference copy.

13. The method of claim 12, wherein said merging step comprises removing said one or more design elements of said second reference copy from said modified global model if said one or more design elements of said second reference copy are not present in said first user copy.

14. The method of claim 13, wherein said merging step comprises modifying said one or more design elements of said modified global model to match changes observed to said one or more design elements of said second user copy.

15. The method of claim 1, further comprising the step of displaying a user interface, wherein said user interface includes said global model.

16. The method of claim 15, wherein said user interface includes a merge window for merging said first local model with said second local model in said modified global model.

17. The method of claim 16, wherein said merge window includes a global input, a global output, and a plurality of local inputs.

18. A method of integrating design element changes into a global model, comprising:
converting a modeling source into a binary data file by a computer system, wherein said binary data file includes a global model;
loading said global model by said computer system, wherein said global model includes a plurality of design elements;
extracting a first local model from said global model, wherein said first local model includes one or more of said design elements, wherein said first local model comprises a first user copy and a first reference copy;
extracting a second local model from said global model, wherein said second local model includes one or more of said design elements, wherein said second local model includes a second user copy and a second reference copy;
modifying said one or more design elements of said first local model in said first user copy, wherein said first reference copy is not changed;
modifying said one or more design elements of second local model in said second user copy, wherein said second reference copy is not changed;
comparing said first user copy with said first reference copy;
adding said one or more design elements of said first user copy to a modified global model if said one or more design elements of said first user copy are not present in said first reference copy;
removing said one or more design elements of said first reference copy from said modified global model if said one or more design elements of said first reference copy are not present in said first user copy; and
modifying said one or more design elements of said global model and saving to said modified global model to match changes observed to said one or more design elements of said first user copy when compared with said first reference copy.

19. The method of claim 18, further comprising the steps of:
adding said one or more design elements of said second user copy to said modified global model if said one or more design elements of said second user copy are not present in said second reference copy;
removing said one or more design elements of said second reference copy from said modified global model if said one or more design elements of said second reference copy are not present in said second user copy; and
modifying said one or more design elements of said global model and saving to said modified global model to match changes observed to said one or more design elements of said second user copy when compared with said second reference copy.

20. The method of claim 19, further comprising the step of eliminating duplicate ID's in said modified global model.
